(19) United States
(12) Patent Application Publication
(10) Pub. No.: US 2025/0065895 A1
(43) Pub. Date: Feb. 27, 2025

(54) AUTONOMOUS DRIVING VEHICLE AND A CONTROL METHOD THEREOF

(71) Applicants: HYUNDAI MOTOR COMPANY, Seoul (KR); KIA CORPORATION, Seoul (KR)

(72) Inventor: Jun Hyung Song, Hwaseong-si (KR)

(73) Assignees: HYUNDAI MOTOR COMPANY, Seoul (KR); KIA CORPORATION, Seoul (KR)

(21) Appl. No.: 18/813,836

(22) Filed: Aug. 23, 2024

(30) Foreign Application Priority Data
Aug. 25, 2023 (KR) 10-2023-0111948

(51) Int. Cl. B60W 50/06; B60W 60/00

(52) U.S. Cl. CPC B60W 50/06; B60W 60/0015; B60W 2552/05

(57) ABSTRACT

A method of controlling an autonomous vehicle includes: under the control of the processor, recognizing at least one vehicle driving around the autonomous vehicle within a preset reference range, setting at least one target vehicle by assigning an identifier (ID) to at least one among the at least one vehicle, analyzing a driving pattern of the at least one target vehicle, and determining a risk level with respect to the at least one target vehicle based on a result of the analyzing.

### CROSS-REFERENCE TO RELATED APPLICATIONS

This application claims priority to Korean Patent Application No. 10-2023-0111948, filed on Aug. 25, 2023, the entire contents of which are hereby incorporated by reference.

### BACKGROUND

### Technical Field

The present disclosure relates to an autonomous vehicle and a control method thereof and, more particularly, to an autonomous vehicle and a control method thereof that establishes a standard for comprehensive determination.

### Related Art

Autonomous vehicles, which may reduce driver fatigue by performing driving, braking, and steering on behalf of the driver, are recently required to have the ability to adaptively respond to surrounding situations that change in real time while driving.

To mass produce autonomous vehicles and to promote the use of the autonomous vehicles, a reliable determination control function may be required above all. For example, recent commercial vehicles are equipped with various functions, for example, a highway driving assist (HAD) function; a driver state warning (DSW) function that determines drowsy driving, distracted gaze, and driver's carelessness and abnormal conditions and outputs a warning alarm through a cluster and the like; a driver attention warning (DAW) function that checks whether a vehicle drives unsafely by crossing lanes through a front camera; and a forward collision-avoidance assist (FCA) function or active emergency braking system (AEBS) that performs sudden braking when a forward collision is detected.

The DAW function may detect driving patterns such as longitudinal acceleration/deceleration driving patterns, lateral displacement size, steering torque, lateral jerk, and lane departure, using a front camera, to determine a driving alert level.

Among the typical functions described above, the DAW function may operate only for an ego vehicle and may not determine a state of a driver of a nearby vehicle driving around.

In addition, because an autonomous driving function is activated when a risk of an accident with a nearby vehicle present around is detected, the behavior of the nearby vehicle may not be predicted or determined in advance.

The statements in this BACKGROUND section merely provide background information related to the present disclosure and may not constitute prior art.

### SUMMARY

An object of the present disclosure is to provide an autonomous vehicle and its control method that may predict and determine a driver state and a driving state risk of a nearby vehicle by using at least one sensor to strengthen defensive driving for the nearby vehicle during driving, and when a dangerous situation is determined, may provide a caution or warning to reduce a risk of an accident.

In addition, another object of the present disclosure is to provide an autonomous vehicle and its control method that may establish a standard for comprehensively determining a risk level of a nearby vehicle, define in real time a risk level of a nearby vehicle for each identifier (ID) based on a determined driver state and driving tendency, and provide a caution or warning to perform defensive driving in advance.

In addition, another object of the present disclosure is to provide an autonomous vehicle and its control method that may continuously track a nearby vehicle by assigning a unique ID to the nearby vehicle, recognizing a vehicle license plate, and transferring a risk level when a target is re-detected after disappearing.

In addition, another object of the present disclosure is to provide an autonomous vehicle and a control method thereof that establishes a standard for comprehensive determination by recognizing a situation where a warning or control of an autonomous driving function operates and warns a drivers of a determined driving alert state.

The technical objects to be achieved by the present disclosure are not limited to those described above, and other technical objects not described above may also be clearly understood by those having ordinary skill in the art from the following description.

To solve the foregoing technical problems, according to an embodiment of the present disclosure, a method of controlling an autonomous vehicle includes: recognizing, by the processor, at least one vehicle driving around the autonomous vehicle within a preset reference range; setting, by the processor, at least one target vehicle by assigning an identifier (ID) to at least one among the at least one vehicle; analyzing, by the processor, a driving pattern of the at least one target vehicle; and determining, by the processor, a risk level with respect to the at least one target vehicle based on a result of the analyzing.

In at least one embodiment of the present disclosure, the method further includes analyzing, by the processor, the driving pattern based on a driving status criterion set differently based on a directional behavior of the at least one target vehicle.

In at least one embodiment of the present disclosure, the driving status criterion includes a first driving status criterion with respect to a longitudinal behavior and a second driving status criterion with respect to a lateral behavior. For example, the driving status criterion comprises a first driving status criterion and a second driving status criterion. The method may further include: under the control of the processor, setting, in response to a longitudinal behavior of the at least one target vehicle, the first driving status criterion; and setting, in response to a lateral behavior of the at least on target vehicle, the second driving status criterion.

In at least one embodiment of the present disclosure, the first driving status criterion is set based on an absolute value change in a longitudinal position/speed/acceleration of the at least one target vehicle (e.g., an absolute value change in at least one of a longitudinal position, a longitudinal speed, or a longitudinal acceleration of the at least one target vehicle) and a relative value change in the longitudinal position, speed, and/or acceleration with respect to a vehicle in front of the at least one target vehicle (e.g., a relative value change in at least one of a longitudinal position, a longitudinal speed, or a longitudinal acceleration with respect to a vehicle in front of the at least one target vehicle).

In at least one embodiment of the present disclosure, the second driving status criterion includes one or more criteria related to when the target vehicle is located at a center of a lane but continues steering, when the target vehicle turns by steering greater than a curvature of a straight road or a curved road on which the target vehicle is driving, or when the target vehicle changes steering from steering less than the curvature of the curved road on which the target vehicle is driving to steering greater to steering greater than the curvature of the cured road.

In at least one embodiment of the present disclosure, the method further includes: in response that the directional behavior of the at least one target vehicle departs from the first driving status criterion or the second driving status criterion (e.g., in response to a departure of the directional behavior of the at least one target vehicle from the first driving status criterion or the second driving status criterion, calculating a risk score), calculating, by the processor, a risk score; accumulating, by the processor, the calculated risk score; and determining, by the processor, the risk level based on the accumulated risk score and a plurality of preset reference levels.

In at least one embodiment of the present disclosure, the method further includes applying, by the processor, a weight to the risk score calculated correspondingly to the departure from the second driving status criterion.

In at least one embodiment of the present disclosure, the method further includes: in response that the risk level is determined to be a danger level among the plurality of preset reference levels (e.g., in response to determination that the risk level is a danger level among the plurality of preset reference levels), recognizing, by the processor, a license plate of the at least one target vehicle and storing the recognized license plate; and in response that the at least one target vehicle is re-detected after departing from the preset reference range (e.g., in response to re-detection of the at least one target vehicle after departing from the preset reference range), setting, by the processor, a previous danger level as a current danger level for the re-detected target vehicle.

In at least one embodiment of the present disclosure, the method further includes, in response that the at least one target vehicle departs from a preset safety speed or a preset safety distance (e.g., in response to a departure of the at least one target vehicle from a preset safety speed or a preset safety distance), setting, by the processor, the at least one target vehicle as a danger level.

In at least one embodiment of the present disclosure, the recognizing of the at least one vehicle includes recognizing a plurality of vehicles driving around the autonomous vehicle within a preset reference range, the setting of the at least one target vehicle includes setting a plurality of target vehicles by assigning an ID to each of the plurality of vehicles, the analyzing of the driving pattern includes analyzing a driving pattern of each of the plurality of target vehicles, and the determining of the risk level includes determining a risk level with respect to each of the plurality of target vehicles based on a result of the analyzing of the corresponding driving pattern.

Also, according to an embodiment of the present disclosure, a non-transitory computer-readable storage medium stores instructions that, when executed by a processor, cause the processor to perform the method described above.

Also, according to an embodiment of the present disclosure, an autonomous vehicle includes a processor. The processor is configured to recognize at least one vehicle driving around the autonomous vehicle within a preset reference range, set at least one target vehicle by assigning an identifier (ID) to at least one among the at least one vehicle, analyze a driving pattern of the at least one target vehicle, and determine a risk level with respect to the at least one target vehicle based on a result of the analyzing.

According to an embodiment of the present disclosure, the processor is further configured to analyze the driving pattern based on a driving status criterion set differently based on a directional behavior of the at least one target vehicle.

According to an embodiment of the present disclosure, the driving status criterion includes a first driving status criterion with respect to a longitudinal behavior and a second driving status criterion with respect to a lateral behavior.

According to an embodiment of the present disclosure, the first driving status criterion is set based on an absolute value change in a longitudinal position/speed/acceleration of the at least one target vehicle (e.g., an absolute value change in at least one of a longitudinal position, a longitudinal speed, or a longitudinal acceleration of the at least one target vehicle) and a relative value change in the longitudinal position/speed/acceleration with respect to a vehicle in front of the at least one target vehicle (e.g., a relative value change in at least one of a longitudinal position, a longitudinal speed, or a longitudinal acceleration with respect to a vehicle in front of the at least one target vehicle).

According to an embodiment of the present disclosure, the second driving status criterion includes one or more criteria related to when the target vehicle is located at a center of a lane but continues steering, when the target vehicle turns by steering greater than a curvature of a straight road or a curved road on which the target vehicle is driving, or when the target vehicle changes steering from steering less than the curvature of the curved road on which the target vehicle is driving to steering greater than the curvature of the cured road.

According to an embodiment of the present disclosure, the processor is further configured to: in response that the directional behavior of the at least one target vehicle departs from the first driving status criterion or the second driving status criterion (e.g., in response to a departure of the directional behavior of the at least one target vehicle from the first driving status criterion or the second driving status criterion), calculate a risk score; accumulate the calculated risk score; and determine the risk level based on the accumulated risk score and a plurality of preset reference levels.

According to an embodiment of the present disclosure, the processor is further configured to apply a weight to the risk score calculated correspondingly to the departure from the second driving status criterion.

According to an embodiment of the present disclosure, the processor is further configured to: in response that the risk level is determined to be a danger level among the plurality of reference levels (e.g., in response to determination that the risk level is a danger level among the plurality of preset reference levels), recognize a license plate of the at least one target vehicle and store the recognized license plate; and in response that the at least one target vehicle is re-detected after departing from the preset reference range (e.g., in response to re-detection of the at least one target vehicle after departing from the preset reference range), set a previous danger level as a current danger level for the re-detected target vehicle.

According to an embodiment of the present disclosure, the processor is further configured to in response that the at least one target vehicle departs from a preset safety speed or a preset safety distance (e.g., in response to a departure of the at least one target vehicle from a preset safety speed or a preset safety distance), immediately set the at least one target vehicle as a danger level.

According to embodiments of the present disclosure described herein, an autonomous vehicle and its control method may predict a driver state of a nearby vehicle while an autonomous driving function or a driver themselves is controlling the autonomous vehicle, thereby stably performing defensive driving and improving driving stability.

In addition, the autonomous vehicle and its control method may predict and determine the driver state and driving state risk of the nearby vehicle using at least one sensor to strengthen defensive driving against the nearby vehicle while driving, and when a dangerous situation is determined, provide a caution or warning to reduce a risk of an accident.

In addition, the autonomous vehicle and its control method may establish a standard for comprehensively determining a risk of the nearby vehicle, define in real time the risk of the nearby vehicle for each ID based on the determined driver state and driving tendency, and provide a caution or warning to perform defensive driving in advance.

In addition, the autonomous vehicle and its control method may continuously track a target vehicle by assigning a unique ID to a nearby vehicle and recognizing a license plate, thereby transferring a risk level when the target vehicle is re-detected after disappearing.

The effects that can be achieved from the present disclosure are not limited to those described above, and other effects not described above may also be clearly understood by those having ordinary skill in the art from the following description.

### BRIEF DESCRIPTION OF THE DRAWINGS

FIG. 1 is a block diagram illustrating an autonomous vehicle according to an embodiment of the present disclosure.

FIG. 2 is a diagram illustrating an example of setting a preset reference range according to an embodiment of the present disclosure.

FIG. 3 is a diagram illustrating a method of controlling an autonomous vehicle according to an embodiment of the present disclosure.

FIG. 4 is a flowchart illustrating a method of controlling an autonomous vehicle according to an embodiment of the present disclosure.

FIGS. 5-7 are diagrams illustrating a method of controlling an autonomous vehicle according to an embodiment of the present disclosure.

FIG. 8 is a diagram illustrating a plurality of reference levels according to an embodiment of the present disclosure.

FIG. 9 is a diagram illustrating nearby vehicles displayed on a display unit according to an embodiment of the present disclosure.

The drawings described herein are for illustration purposes only and are not intended to limit the scope of the present disclosure in any way.

### DETAILED DESCRIPTION

Hereinbelow, embodiments of the present disclosure are described in detail with reference to the accompanying drawings, and the same or similar elements are given the same reference numerals regardless of reference symbols, and a repeated description thereof are omitted. Further, in describing the embodiments, when it is determined that a detailed description of related publicly known technology may obscure the gist of the embodiments described herein, the detailed description thereof are omitted.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the embodiments with reference to the accompanying drawings, like reference numerals refer to like components and a repeated description related thereto is omitted.

In addition, the terms “unit” and “control unit” included in names such as a vehicle control unit (VCU) may be terms widely used in the naming of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and a processor that performs determination, calculation, selection, and the like necessary to control the function. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

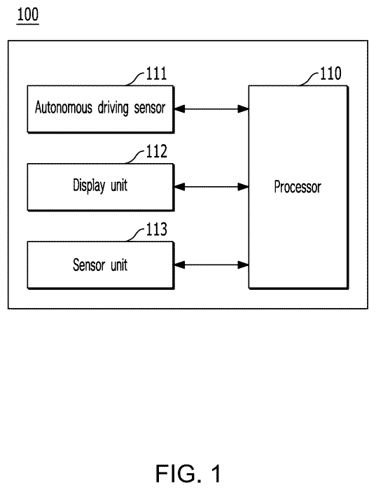

FIG. 1 is a block diagram illustrating an autonomous vehicle according to an embodiment of the present disclosure.

Referring to FIG. 1, according to an embodiment of the present disclosure, an autonomous vehicle 100 may include a processor 110, an autonomous driving sensor 111, a display unit 112, and a sensor unit 113.

The autonomous driving sensor 111 may sense nearby vehicles around the autonomous vehicle 100 driving on a road. For example, by the processor 110 or under the control of the processor 110, the autonomous driving sensor 111 may assign a unique identifier (ID) to a nearby vehicle and continuously track the unique ID until a target vehicle to which the unique ID has been assigned disappears.

In addition, by the processor 110 or under the control of the processor 110, the autonomous driving sensor 111 may sense the longitudinal/lateral position, speed, acceleration, and the like of the nearby vehicles or the target vehicle.

The display unit 112 may be provided in the autonomous vehicle 100 and display various information related to the autonomous vehicle 100 driving on a driving path and various information related to the nearby vehicles around the autonomous vehicle 100. The display unit 112 may also be referred to as a vehicle display or a digital cluster.

For example, the display unit 112 may provide the driver with driving-related information such as speed, fuel amount, vehicle driving information, accumulated driving distance, and distance to a vehicle ahead, and various information including, for example, forward collision-avoidance assist (FCA) information, lane keeping assist (LKA) information, blind-spot collision-avoidance assist (BCA) information, smart cruise control (SCC) information, lane following assist (LFA) information, navigation information, and the like.

For example, the display unit 112 may display a unique ID assigned to each of a plurality of nearby vehicles. This is described in detail below.

The sensor unit 113 may include a plurality of sensors which are detection sensors provided in the autonomous vehicle 100 or arranged in the front or rear of or on the sides of the autonomous vehicle 100. For example, it may include a radar, a lidar, a camera, and the like.

The radar (not shown) may be provided as one or more radars in the autonomous vehicle 100. The radar may measure a relative speed and relative distance with respect to a recognized object, together with a wheel speed sensor (not shown) mounted on the autonomous vehicle 100.

The lidar (not shown) may be provided as one or more lidars in the autonomous vehicle 100. The lidar may irradiate a laser pulse to an object, measure a time at which the laser pulse reflected from the object within a measurement range returns, sense information such as a distance to the object, a direction and speed of the object, and the like, and output lidar data based on the sensed information.

The camera (not shown) may be provided as one or more cameras in the autonomous vehicle 100. The camera may capture images of objects around the autonomous vehicle 100 and their states and output image data based on the captured information.

The processor 110 may recognize a plurality of nearby vehicles driving around the autonomous vehicle 100 within a preset reference range while the autonomous vehicle 100 is driving on a road; assign an ID to each of the recognized plurality of nearby vehicles and set a target vehicle; analyze a driving pattern of the set target vehicle; and determine a risk level with respect to the target vehicle based on a result of the analysis. This is described in detail below.

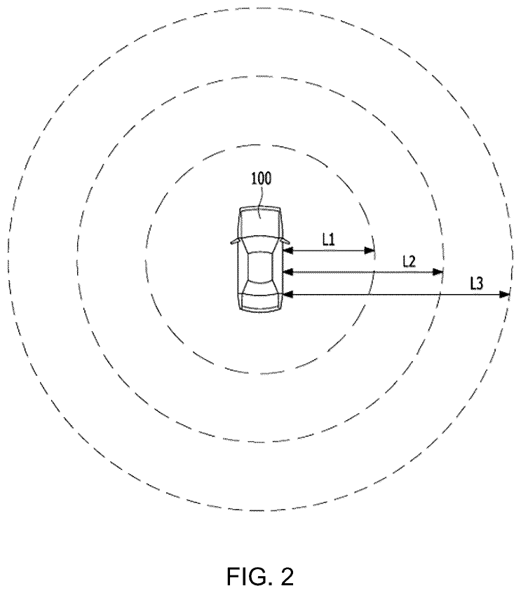

FIG. 2 is a diagram illustrating an example of setting a preset reference range according to an embodiment of the present disclosure.

Referring to FIG. 2, by the processor 110 or under the control of the processor 110, the autonomous vehicle 100 may set a reference range based on the autonomous vehicle 100 driving on a road.

The reference range may include, for example, a first safety range L1, a second safety range L2, and a third safety range L3.

The first safety range L1 may be approximately 0.5 meters (m) or less from the autonomous vehicle 100, the second safety range L2 may be approximately 0.5 m or more and 1.5 m or less from the autonomous vehicle 100, and the third safety range L3 may be 1.5 m or more and 2.5 m or less from the autonomous vehicle 100.

For example, when at least one nearby vehicle is located within the first safety range L1, the processor 110 may determine a danger level. When at least one nearby vehicle is located within the second safety range L2, the processor 110 may determine a warning level.

When at least one nearby vehicle is located within the third safety range L3, the processor 110 may determine a caution level. When at least one nearby vehicle is located outside the third safety range L3, the processor 110 may determine a normal level.

However, examples are not limited thereto, and they may vary according to the speed of the autonomous vehicle 100 or the number of nearby vehicles.

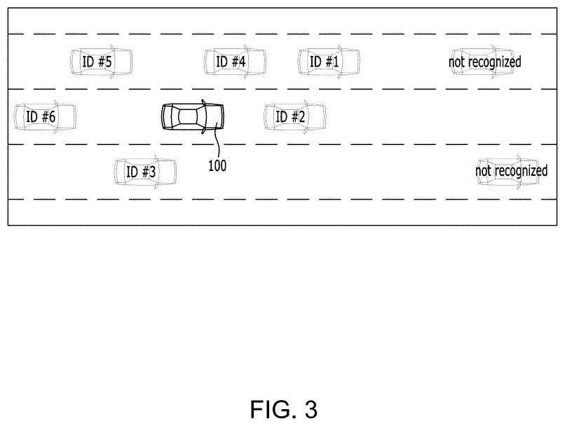

FIG. 3 is a diagram illustrating an example of assigning an ID to each of a plurality of nearby vehicles driving around an autonomous vehicle according to an embodiment of the present disclosure.

Referring to FIG. 3, by the processor 110 or under the control of the processor 110, the autonomous vehicle 100 may recognize a plurality of nearby vehicles driving around the autonomous vehicle 100 within a preset reference range while the autonomous vehicle 100 is driving on a road. In this case, by the processor 110 or under the control of the processor 110, the autonomous vehicle 100 may not recognize nearby vehicles that are out of the preset reference range.

For example, by the processor 110 or under the control of the processor 110, the autonomous vehicle 100 may assign a unique ID to each of the plurality of nearby vehicles recognized within the preset reference range in order they are recognized. However, examples are not limited thereto, and the unique ID may be assigned randomly.

For example, when the plurality of nearby vehicles includes first to sixth nearby vehicles, the processor 110 may assign ID #1 to the first nearby vehicle, ID #2 to the second nearby vehicle, ID #3 to the third nearby vehicle, ID #4 to the fourth nearby vehicle, ID #5 to the fifth nearby vehicle, and ID #6 to the sixth nearby vehicle.

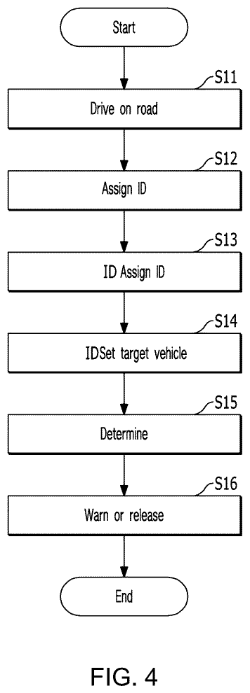

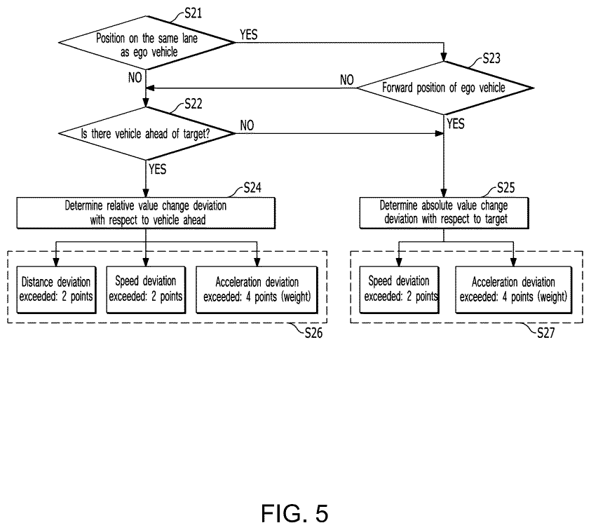

FIG. 4 is a flowchart illustrating a method of controlling an autonomous vehicle according to an embodiment of the present disclosure. FIGS. 5-7 are diagrams illustrating a detailed method of controlling an autonomous vehicle according to an embodiment of the present disclosure.

Referring to FIG. 4, in step S11, by the processor 110 or under the control of the processor 110, the autonomous vehicle 100 may drive on a road.

In step S12, by the processor 110 or under the control of the processor 110, the autonomous vehicle 100 may recognize a plurality of nearby vehicles driving around the autonomous vehicle 100 within a preset reference range while the autonomous vehicle 100 is driving on the road.

In step S13, by the processor 110 or under the control of the processor 110, the autonomous vehicle 100 may assign an ID to each of the recognized plurality of nearby vehicles. This has been described above, and a more detailed description thereof is therefore omitted here.

In step S14, by the processor 110 or under the control of the processor 110, the autonomous vehicle 100 may set, as a target vehicle, each nearby vehicle to which the ID is assigned. By the processor 110 or under the control of the processor 110, the autonomous vehicle 100 may analyze a driving pattern of the set target vehicle.

For example, by the processor 110 or under the control of the processor 110, the autonomous vehicle 100 may analyze the driving pattern by setting a driving status criterion set differently based on a direction of the target vehicle (e.g., according to a direction of the target vehicle). The driving status criterion may include a first driving status criterion and a second driving status criterion.

by the processor 110 or under the control of the processor 110, the autonomous vehicle 100 may set the first driving status criterion when the direction of the target vehicle is longitudinal, and set the second driving status criterion when the direction of the target vehicle is lateral.

The first driving status criterion may be set based on an absolute value change in the longitudinal position/speed/acceleration of the target vehicle (e.g., an absolute value change in at least one of a longitudinal position, a longitudinal speed, or a longitudinal acceleration of the at least one target vehicle) and a relative value change with respect to a vehicle in front of the target vehicle.

The second driving status criterion may correspond to one of the following cases: when the target vehicle is located at the center of a lane but steers continuously; when the target vehicle turns by steering greater than the curvature of a straight/curved road on which the target vehicle is driving; and when the target vehicle changes steering from steering less than the curvature of the curved road on which the target vehicle is driving to steering greater than the curvature of the curved road. This is described in greater detail below.

In step S15, by the processor 110 or under the control of the processor 110, the autonomous vehicle 100 may determine a risk level with respect to the target vehicle based on a result of the analysis.

For example, by the processor 110 or under the control of the processor 110, in the case of being out of the first driving status criterion or the second driving status criterion, the autonomous vehicle 100 may calculate a risk score, accumulate the calculated risk score, and determine the risk level by applying the accumulated risk score to a plurality of preset reference levels. This is described in greater detail below.

By the processor 110 or under the control of the processor 110, the autonomous vehicle 100 may warn the driver or release the set target vehicle based on a result of the determination. In other words, by the processor 110 or under the control of the processor 110, the autonomous vehicle 100 may delete the assigned ID when the target vehicle departs from the preset reference range.

As described above, by the processor 110 or under the control of the processor 110, the autonomous vehicle 100 may assign a unique ID to a nearby vehicle detected by the autonomous driving sensor 111, and continuously track the unique ID until a target vehicle to which the unique ID is assigned departs from the preset reference range.

Referring to FIG. 5, by the processor 110 or under the control of the processor 110, the autonomous vehicle 100 may set the first driving status criterion when a direction of a target vehicle is longitudinal and may calculate a risk score based on this. In other words, by the processor 110 or under the control of the processor 110, the autonomous vehicle 100 may determine the appropriateness of acceleration/deceleration control for the target vehicle.

In step S21, by the processor 110 or under the control of the processor 110, the autonomous vehicle 100 may sense whether the target vehicle is located on the same lane.

By the processor 110 or under the control of the processor 110, while determining the target vehicle is located on the same lane, the autonomous vehicle 100 may determine whether the target vehicle is located ahead (Yes in S23) or behind (No in S23) based on the autonomous vehicle 100.

For example, in a situation where the target vehicle is located ahead of the autonomous vehicle 100 on the same lane as the autonomous vehicle 100, the processor 110 may determine the set first driving status criterion based on a deviation of an absolute value change in step S25. In this case, the situation may include a situation where a vehicle ahead of the target vehicle is not recognized.

In this case, the deviation of the absolute value change may be 3 meters per second (m/s) based on a speed deviation and 3 meters per second squared (m/s²) based on an acceleration deviation. For example, when the speed deviation of the absolute value is 3 m/s or more, the processor 110 may determine that the first driving status criterion is exceeded and calculate the risk score of 2 points from the excess of the speed deviation.

Alternatively, when the acceleration deviation of the absolute value is 3 m/s² or more, the processor 110 may determine that the first driving status criterion is exceeded and calculate the risk score of 4 points from the excess of the acceleration deviation. In this case, the processor 110 may calculate the risk score by assigning a weight when the acceleration deviation is exceeded in step S27.

By the processor 110 or under the control of the processor 110, the autonomous vehicle 100 may determine whether the target vehicle is not located on the same lane but is located on a neighboring lane. For example, in a situation where the target vehicle is located on a lane next to or behind the same lane, rather than on the same lane as the autonomous vehicle 100, the processor 110 may determine the set first driving status criterion based on a deviation of the relative value change in step S24. In this case, the situation may include a situation where a vehicle ahead of the target vehicle is recognized.

In this case, the deviation of the relative value change may be 10 m based on a distance deviation, 3 m/s based on a speed deviation, and 3 m/s² based on an acceleration deviation. For example, when the distance deviation of the relative value is 10 m or more, the processor 110 may determine that the first driving status criterion is exceeded and calculate the risk score of 2 points from the excess of the distance deviation. Alternatively, when the speed deviation of the relative value is 3 m/s or more, the processor 110 may determine that the first driving status criterion is exceeded and calculate the risk score of 2 points from the excess of the speed deviation.

Alternatively, when the acceleration deviation of the relative value is 3 m/s² or more, the processor 110 may determine that the first driving status criterion is exceeded and calculate the risk score of 4 points from the excess of the acceleration deviation. In this case, the processor 110 may calculate the risk score by assigning a weight when the acceleration deviation is exceeded in step S26. In such a case of a large change in acceleration, the weight may be added because the large change in acceleration compared to distance/speed is highly likely due to unfamiliar or poor vehicle control.

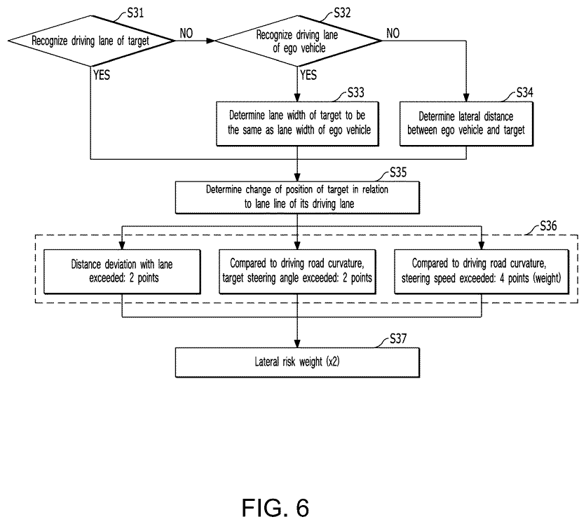

Referring to FIG. 6, by the processor 110 or under the control of the processor 110, the autonomous vehicle 100 may set the second driving status criterion when the direction of the target vehicle is lateral and calculate a risk score based on this. In other words, by the processor 110 or under the control of the processor 110, the autonomous vehicle 100 may determine the appropriateness of the steering control of a target vehicle.

In step S31, by the processor 110 or under the control of the processor 110, the autonomous vehicle 100 may recognize a driving lane of the target vehicle using the autonomous driving sensor 111.

By the processor 110 or under the control of the processor 110, when the driving lane of the target vehicle is not recognized using the autonomous driving sensor 111, the autonomous vehicle 100 may recognize a driving lane of the autonomous vehicle 100 in step S32.

By the processor 110 or under the control of the processor 110, when the driving lane of the autonomous vehicle 100 is recognized using the autonomous driving sensor 111, the autonomous vehicle 100 may set the second driving status criterion based on the width of the lane of the autonomous vehicle 100 and the width of the lane of the target vehicle in step S33, and may analyze a change between the target vehicle and the driving lane based on the set second driving status criterion in step S35.

Alternatively, by the processor 110 or under the control of the processor 110, when the driving lane of the autonomous vehicle 100 is not recognized using the autonomous navigation sensor 111, the autonomous vehicle 100 may calculate a distance or gap between the autonomous vehicle 100 and the target vehicle based on a lateral direction and set the second driving status criterion based on the calculated distance in step S34, and may analyze a change or deviation between the target vehicle and the driving lane based on the set second driving status criterion in step S35.

In this case, the deviation between the target vehicle and the driving lane may be 0.5 m based on a distance deviation, 10 degrees (or deg) based on a steering angle difference, and 4 degrees per second (deg/s) based on a steering speed. For example, when the distance deviation between the target vehicle and the driving lane is 0.5 m or more, the processor 110 may determine that the second driving status criterion is exceeded and calculate the risk score of 2 points from the excess of the distance deviation.

When the difference in steering angle between the target vehicle and the driving lane is 10 deg or more, the processor 110 may determine that the second driving status criterion is exceeded and calculate the risk score of 2 points from the excess of the steering angle compared to the curvature of the driving road. When the steering speed between the target vehicle and the driving lane is 4 deg/s or more, the processor 110 may determine that the second driving status criterion is exceeded and calculate the risk score of 2 points from the excess of the steering speed compared to the curvature of the driving road in step S36. In this case, the processor 110 may calculate the risk score by assigning a weight when the steering speed is exceeded compared to the curvature of the driving road.

In addition, in step S37, by the processor 110 or under the control of the processor 110, the autonomous vehicle 100 may add a certain weight to the risk score calculated from the departure from the second driving status criterion. The weight may be added in this way because there is a high probability of an accident due to unfamiliar or poor control in the lateral direction of the target vehicle driving on a side lane compared to the longitudinal direction.

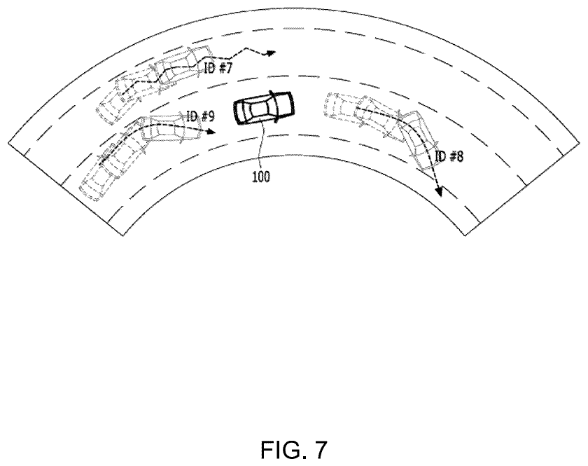

Referring to FIG. 7, for example, when a target vehicle (e.g., ID #7) is located at the center of a lane but steering continuously, when a target vehicle (e.g., ID #8) turns by steering greater than the curvature of a straight/curved road on which it is driving, or when a target vehicle (e.g., ID #9) changes steering from steering less than the curvature of a curved road on which it is driving to steering greater than the curvature of the curved road, the autonomous vehicle 100 may determine a departure from the set second driving status criterion, by the processor 110 or under the control of the processor 110.

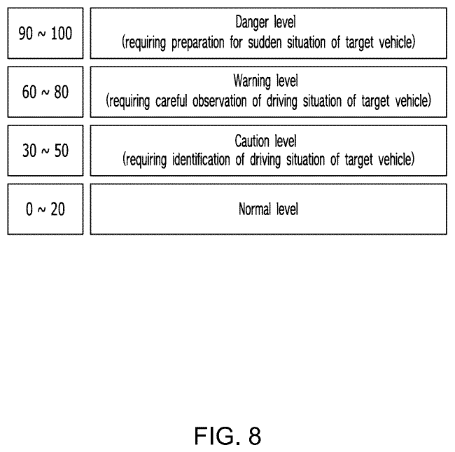

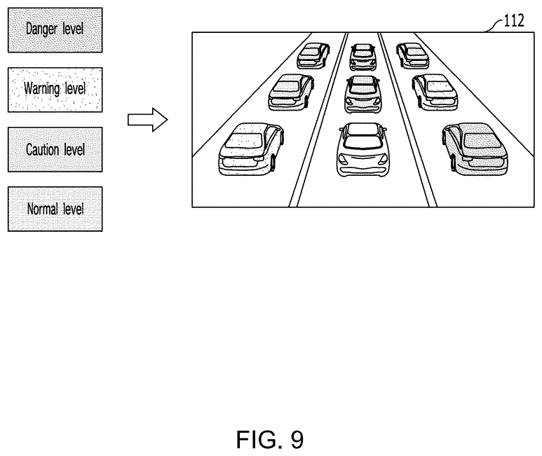

FIG. 8 is a diagram illustrating a plurality of reference levels according to an embodiment of the present disclosure. FIG. 9 is a diagram illustrating nearby vehicles displayed on a display unit according to an embodiment of the present disclosure.

Referring to FIG. 8, by the processor 110 or under the control of the processor 110, the autonomous vehicle 100 may accumulate calculated risk scores and apply the accumulated risk score to a plurality of preset reference levels to determine a risk level with respect to a target vehicle.

The reference levels may include one or more levels. For example, the reference levels may include first to fourth reference levels (Lv1 to Lv4).

The first reference level Lv1 may correspond to the accumulated risk score of 20 points or less. The first reference level Lv1 may be a normal level.

The second standard level Lv2 may correspond to the accumulated risk score of 30 or more and 50 or less. The second reference level Lv2 may be a caution level, which requires driving by identifying a driving situation of a target vehicle.

The third standard level Lv3 may correspond to the accumulated risk score of 60 or more and 80 or less. The third reference level Lv3 may be a warning level, which requires driving by carefully observing a driving situation of a target vehicle.

The fourth standard level Lv4 may correspond to the accumulated risk score of 90 or more and 100 or less. The fourth standard level Lv4 may be a danger level, which requires driving in preparation for an unexpected situation of a target vehicle. In addition, by the processor 110 or under the control of the processor 110, the autonomous vehicle 100 may display a result of the determined risk level through the display unit 112.

As shown in FIG. 9, by the processor 110 or under the control of the processor 110, the autonomous vehicle 100 may display the colors of target vehicles differently according to the plurality of reference levels.

However, examples are not limited thereto, and the target vehicles may be displayed in various colors. In addition, the processor 110 may output warning sounds, messages, or blinks differently according to the plurality of reference levels, together with the display unit 112.

As described above, the risk level for a nearby vehicle may be classified into the normal, caution, warning, and danger levels based on the scores.

For example, the risk level of nearby vehicles may be defined in real time for each ID of each target vehicle, and the danger level among the plurality of reference levels may be displayed and provide a warning through the display unit 112.

When the risk level is determined as the danger level among the plurality of reference levels, the autonomous vehicle 100 may recognize a license plate of the target vehicle, store the recognized license plate, and transfer the danger level when the target vehicle is re-detected after departing from the preset reference range, by the processor 110 or under the control of the processor 110.

In other words, the autonomous vehicle 100 may store the license plate of the target vehicle having the “danger level” among the plurality of reference levels, along with the score, and transfer the score of the risk level when there is the same license plate as the stored license plate of the “danger level” vehicle after the target vehicle is re-detected after being out of sight.

In addition, when the target vehicle departs from a preset safety speed or safety distance within the preset reference range, the autonomous vehicle 100 may immediately set the danger level, by the processor 110 or under the control of the processor 110.

For example, this may be a case where the target vehicle rapidly approaches the autonomous vehicle 100. For example, this may be a case where a time-to-collision (TTC) is less than 3 seconds(s) or the target vehicle is within a first safety range that is less than 0.5 m.

As described above, according to an embodiment of the present disclosure, the autonomous vehicle 100 and its control method may predict a driver state of a nearby vehicle while an autonomous driving function 4 the driver themselves is controlling the vehicle, thereby enabling stable defensive driving and improving driving stability.

In addition, according to an embodiment of the present disclosure, the autonomous vehicle 100 and its control method may predict and determine a driver state of a nearby vehicle and a risk level of a driving state using at least one sensor to strengthen defensive driving against the nearby vehicle while driving, and may provide a caution or warning in response to a dangerous situation being determined, thereby reducing the risk of an accident.

In addition, according to an embodiment of the present disclosure, the autonomous vehicle 100 and its control method may establish a standard for comprehensively determining a risk level of a nearby vehicle, define in real time a risk level of a nearby vehicle for each ID based on a determined driver state and driving tendency, and provide a caution or warning, thereby performing defensive driving in advance.

In addition, according to an embodiment of the present disclosure, the autonomous vehicle 100 and its control method may assign a unique ID to each nearby vehicle and recognize a license plate, and transfer a risk level when a target vehicle is re-detected after being out of sight, thereby continuously tracking the target vehicle.

The embodiments of the present disclosure described herein may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like.

Accordingly, the foregoing detailed description should not be construed as restrictive but as illustrative in all respects. The scope of the embodiments of the present disclosure should be determined by reasonable interpretation of the appended claims, and all changes and modifications within the equivalent scope of the present disclosure are included in the scope of the present disclosure.

What is claimed is:

1. A method of controlling an autonomous vehicle comprising a processor, the method comprising:
recognizing, by the processor, at least one vehicle driving around the autonomous vehicle within a preset reference range;
setting, by the processor, at least one target vehicle by assigning an identifier (ID) to at least one among the at least one vehicle;
analyzing, by the processor, a driving pattern of the at least one target vehicle; and
determining, by the processor, a risk level with respect to the at least one target vehicle based on a result of the analyzing.

2. The method of claim 1, further comprising:
analyzing, by the processor, the driving pattern based on a driving status criterion set differently based on a directional behavior of the at least one target vehicle.

3. The method of claim 2, wherein the driving status criterion comprises a first driving status criterion with respect to a longitudinal behavior and a second driving status criterion with respect to a lateral behavior.

4. The method of claim 3, wherein the first driving status criterion is set based on an absolute value change in at least one of a longitudinal position, speed, or acceleration of the at least one target vehicle and a relative value change in t least one of the longitudinal position, speed, or acceleration with respect to a vehicle in front of the at least one target vehicle.

5. The method of claim 4, wherein the second driving status criterion includes one or more criteria related to:
when the target vehicle is located at a center of a lane but continues steering;
when the target vehicle turns by steering greater than a curvature of a straight road or a curved road on which the target vehicle is driving; or
when the target vehicle changes steering from steering less than the curvature of the curved road on which the target vehicle is driving to steering greater than the curvature of the curved road.

6. The method of claim 5, further comprising:
in response to a departure of the directional behavior of the at least one target vehicle from the first driving status criterion or the second driving status criterion, calculating, by the processor, a risk score;
accumulating, by the processor, the calculated risk score; and
determining, by the processor, the risk level based on the accumulated risk score and a plurality of preset reference levels.

7. The method of claim 6, further comprising:
applying, by the processor, a weight to the risk score calculated correspondingly to the departure from the second driving status criterion.

8. The method of claim 6, further comprising:
in response to determination that the risk level is a danger level among the plurality of preset reference levels, recognizing, by the processor, a license plate of the at least one target vehicle and storing the recognized license plate; and
in response to re-detection of the at least one target vehicle after departing from the preset reference range, setting, by the processor, a previous danger level as a current danger level for the re-detected target vehicle.

9. The method of claim 6, further comprising:
in response to a departure of the at least one target vehicle from a preset safety speed or a preset safety distance, setting, by the processor, the at least one target vehicle as a danger level.

10. The method of claim 1, wherein:
the recognizing of the at least one vehicle includes recognizing a plurality of vehicles driving around the autonomous vehicle within a preset reference range;
the setting of the at least one target vehicle includes setting a plurality of target vehicles by assigning an ID to each of the plurality of vehicles;
the analyzing of the driving pattern includes analyzing a driving pattern of each of the plurality of target vehicles; and
the determining of the risk level includes determining a risk level with respect to each of the plurality of target vehicles based on a result of the analyzing of the corresponding driving pattern.

11. A non-transitory computer-readable storage medium storing instructions that, when executed by a processor, cause the processor to perform:
recognizing at least one vehicle driving around an autonomous vehicle within a preset reference range;
setting at least one target vehicle by assigning an identifier (ID) to at least one among the at least one vehicle;
analyzing a driving pattern of the at least one target vehicle; and
determining a risk level with respect to the at least one target vehicle based on a result of the analyzing.

12. An autonomous vehicle comprising a processor, wherein the processor is configured to:
recognize at least one vehicle driving around the autonomous vehicle within a preset reference range;
set at least one target vehicle by assigning an identifier (ID) to at least one among the at least one vehicle;
analyze a driving pattern of the at least one target vehicle; and
determine a risk level with respect to the at least one target vehicle based on a result of the analyzing.

13. The autonomous vehicle of claim 12, wherein the processor is further configured to:
analyze the driving pattern based on a driving status criterion set differently based on a directional behavior of the at least one target vehicle.

14. The autonomous vehicle of claim 13, wherein the driving status criterion comprises a first driving status criterion with respect to a longitudinal behavior and a second driving status criterion with respect to a lateral behavior.

15. The autonomous vehicle of claim 14, wherein the first driving status criterion is set based on an absolute value change in at least one of a longitudinal position, speed, or acceleration of the at least one target vehicle and a relative value change in at least one of the longitudinal position, speed, or acceleration with respect to a vehicle in front of the at least one target vehicle.

16. The autonomous vehicle of claim 15, wherein the second driving status criterion includes one or more criteria related to:
when the target vehicle is located at a center of a lane but continues steering;
when the target vehicle turns by steering greater than a curvature of a straight road or a curved road on which the target vehicle is driving; or
when the target vehicle changes steering from steering less than the curvature of the curved road on which the target vehicle is driving to steering greater than the curvature of the curved road.

17. The autonomous vehicle of claim 16, wherein the processor is further configured to:
in response to a departure of the directional behavior of the at least one target vehicle from the first driving status criterion or the second driving status criterion, calculate a risk score;
accumulate the calculated risk score; and
determine the risk level based on the accumulated risk score and a plurality of preset reference levels.

18. The autonomous vehicle of claim 17, wherein the processor is further configured to:
apply a weight to the risk score calculated correspondingly to the departure from the second driving status criterion.

19. The autonomous vehicle of claim 17, wherein the processor is further configured to:
in response to determination that the risk level is a danger level among the plurality of preset reference levels, recognize a license plate of the at least one target vehicle and store the recognized license plate; and
in response to re-detection of the at least one target vehicle after departing from the preset reference range, set a previous danger level as a current danger level for the re-detected target vehicle.

20. The autonomous vehicle of claim 17, wherein the processor is further configured to:
in response to a departure of the at least one target vehicle from a preset safety speed or a preset safety distance, immediately set the at least one target vehicle as a danger level.
